(19) United States
(12) Patent Application Publication
(10) Pub. No.: US 2008/0232532 A1
(43) Pub. Date: Sep. 25, 2008

(54) Apparatus and Method for Generation of Ultra Low Momentum Neutrons

(76) Inventors: Lewis G. Larsen, Chicago, IL (US); Alan Widom, Brighton, MA (US)

Correspondence Address: COOK, ALEX, MCFARRON, MANZO, CUMMINGS & MEHLER LTD, SUITE 2850, 200 WEST ADAMS STREET, CHICAGO, IL, 60606, US

(21) Appl. No.: 11/912,793

(22) PCT Filed: Apr. 28, 2006
(86) PCT No.: PCT/US06/16379

§ 371 Date: Oct. 26, 2007

Related U.S. Application Data
(60) Provisional application No. 60/676,264, filed on Apr. 29, 2005.
(60) Provisional application No. 60/715,622, filed on Sep. 9, 2005.

(51) Int. Cl. H05H 3/06

(52) U.S. Cl. 376/108

(57) ABSTRACT

Method and apparatus for generating ultra low momentum neutrons (ULMNs) using surface plasmon polariton electrons, hydrogen isotopes, surfaces of metallic substrates, collective many-body effects, and weak interactions in a controlled manner. The ULMNs can be used to trigger nuclear transmutation reactions and produce heat. One aspect of the present invention effectively provides a “transducer” mechanism that permits controllable two-way transfers of energy back-and-forth between chemical and nuclear realms in a small-scale, low-energy, scalable condensed matter system at comparatively modest temperatures and pressures.

### CROSS REFERENCE AND PRIORITY CLAIM

The present application claims the benefit of the following provisional patent applications by the present inventors: (a) “Apparatus and Method for Generation of Ultra Low Momentum Neutrons,” filed at the U.S. Patent and Trademark Office on Apr. 29, 2005 and having Ser. No. 60/676,264; and (b) “Apparatus and Method for Absorption of Incident Gamma Radiation and Its Conversion to Outgoing Radiation at Less Penetrating, Lower Energies and Frequencies,” filed at the U.S. Patent and Trademark Office on Sep. 9, 2005 having Ser. No. 60/715,622.

### BACKGROUND OF THE INVENTION

The present invention concerns apparatus and methods for the generation of extremely low energy neutrons and applications for such neutrons. Neutrons are uncharged elementary fermion particles that, along with protons (which are positively charged elementary fermion particles), comprise an essential component of all atomic nuclei except for that of ordinary hydrogen. Neutrons are well known to be particularly useful for inducing various types of nuclear reactions because, being uncharged, they are not repelled by Coulombic repulsive forces associated with the positive electric charge contributed by protons located in an atomic nucleus. Free neutrons are inherently unstable outside of the immediate environment in and around an atomic nucleus and have an accepted mean life of about 887 to 914 seconds; if they are not captured by an atomic nucleus, they break up via beta decay into an electron, a proton, and an anti-neutrino.

Neutrons are classified by their levels of kinetic energy; expressed in units measured in MeV, meV, KeV, or eV—Mega-, milli-, Kilo- electron Volts. Depending on the mean velocity of neutrons within their immediate physical environment, energy levels of free neutrons can range from: (1) ultracold to cold (nano eVs to 25 meV); (2) thermal (in equilibrium with environment at an E approx.=kT=0.025 eV); (3) slow (0.025 eV to 100 eV—at around 1 eV they are called epithermal); (4) intermediate (100 eV to about 10 KeV); (5) fast (10 KeV to 10 MeV), to ultrafast or high-energy (above 10 MeV). The degree to which a given free neutron possessing a particular level of energy is able to react with a given atomic nucleus/isotope via capture (referred to as the reaction capture “cross section” and empirically measured in units called “barns”) is dependent upon: (a) the specific isotope of the nucleus undergoing a capture reaction with a free neutron, and (b) the mean velocity of a free neutron at the time it interacts with a target nucleus.

It is well known that, for any specific atomic isotope, the capture cross section for reactions with externally supplied free neutrons scales approximately inversely proportional to velocity (1/v). This means that the lower the mean velocity of a free neutron (i.e., the lower the momentum) at the time of interaction with a nucleus, the higher its absorption cross section will be, i.e., the greater the probability that it will react successfully and be captured by a given target nucleus/isotope.

Different atomic isotopes can behave very differently after capturing free neutrons. Some isotopes are entirely stable after the capture of one or more free neutrons (e.g., isotopes of Gadolinium (Gd), atomic number 64: ¹⁵⁴Gd to ¹⁵⁵Gd to ¹⁵⁶Gd). (As used herein, superscripts at the top left side (or digits to the left side) of the elemental symbol represent atomic weight.) Some isotopes absorb one or more neutrons, forming a more neutron-rich isotope of the same element, and then beta decay to another element. Beta decay strictly involves the weak interaction, because it results in the production of neutrinos and energetic electrons (known as β-particles). In beta decay, the neutron number (N) goes down by one; the number of protons (atomic number=Z=nuclear charge) goes up by one; the atomic mass (A=Z+N) is unchanged. Higher-Z elements are thus produced from lower-Z “seed” elements. Other atomic isotopes enter an unstable excited state after capturing one or more free neutrons, and “relax” to a lower energy level by releasing the excess energy through the emission of photons such as gamma rays (e.g., the isotope Cobalt-60 [⁶⁰ Co], atomic number 27). Yet other isotopes also enter unstable excited states after capturing one or more free neutrons, but subsequently “relax” to lower energy levels through spontaneous fission of the “parent” nucleus. At very high values of A, de-excitation processes start being dominated by fission reactions (involving the strong interaction) and alpha particle (Helium-4 nuclei) emission rather than beta decays and emission of energetic electrons and neutrinos. Such fission processes can result in the production of a wide variety of “daughter” isotopes and the release of energetic particles such as protons, alphas, electrons, neutrons, and/or gamma photons (e.g., the isotope ²⁵²Cf of Californium, atomic number 98). Fission processes are commonly associated with certain very heavy (high A) isotopes that can produce many more neutrons than they “consume” via initial capture, thus enabling a particular type of rapidly escalating cascade of neutron production by successive reactions commonly known as a fission “chain reaction” (e.g., the uranium isotope ²³⁵U, atomic number 92; or the plutonium isotope ²³⁹Pu, atomic number 94). For ²³⁵U, each external free “trigger” neutron releases another 100 neutrons in the resulting chain reaction. Isotopes that can produce chain reactions are known as fissile. Deliberately induced neutron-catalyzed chain reactions form the underlying basis for existing nuclear weapons and fission power plant technologies. Significant fluxes of free neutrons at various energies are useful in a variety of existing military, commercial, and research applications, with illustrative examples as follows. It should be noted that an advantage of the present invention is mentioned in the following Table I:

TABLE I

| | Energy Range | Are Reactants and | | |
|---|---|---|---|---|
| | and Flux of | Operating | Examples of | |
| End-Use | Free Neutrons | Conditions Suitable | Existing Apparatus | |
| Application | (n per sec) | for Supporting | Used to Produce | |
| for Neutron | used in | Runaway Chain | Free Neutrons in | |
| Source | Application | Reactions? | Application | Comments |
| Existing | Thermal to | Yes, highly | Nuclear Weapons | Need relatively |
| Nuclear | Ultrafast | accelerated | Components | “fast” neutrons |
| Weapons | | runaway chain | | because desired |
| for the | | reactions are one of | | reactions must occur |
| Military | | the design goals | | very rapidly to have |
| | | | | appropriate |
| | | | | explosive effects |
| Existing | Thermal | Yes, however | Fission Reactor | Desired result is |
| Nuclear | | reaction rates are | optimized for heat | sustained heat |
| Power Plants | | tightly controlled | production used to | production at highly |
| that | | with various types | generate steam that | controlled reaction |
| Generate | | of moderators | spins a turbine | rates so “slower” |
| Electricity | | | | neutrons must be |
| | | | | used |
| Producing | Thermal | No, generally not | Fission Reactor | Bombard target |
| Useful | | in most isotopes | optimized for | materials with |
| Isotopes | | produced for | characteristics of | thermal neutrons in |
| via | | various | neutron flux | reactor to create new |
| Transmutation | | applications | | isotopes |
| Materials | Various | No | Larger (some are | Includes so called |
| Properties | | | GeV Class) | “spallation” neutron |
| Research | | | Particle | sources |
| | | | Accelerators | |
| Materials | Range from | No | Small Portable | Can utilize D-D and |
| Properties | epithermal to | | Accelerators | D-T reactions; good |
| Research | ultrafast; fluxes | | | examples in Thermo |
| Well Bore | average around | | | Electron product line |
| Hole Logging | 10⁸ | | | |
| Neutron | Range from | No | Isotope sources in | For IDC devices, |
| Sources for | epithermal to | | shielded apparatus, | with D-D reaction |
| Applications | ultrafast; fluxes | | or IEC fusion | neutrons are 2.45 |
| Such as | from 10⁻⁶ to | | devices | MeV; D-T neutrons |
| Biomedical | 10¹² | | | are 14 MeV |
| Basic | Ultracold | No | Large fission | The invention |
| Research on | (UCNs) | | reactor connected | enables production |
| Neutron | | | to UCN “trap” via a | of large fluxes of |
| Properties | | | series of | neutrons that have |
| | | | moderators | even lower |
| | | | | momentum than |
| | | | | UCNs |

Locations and Reaction Products of Fluxes of Free Neutrons Found in Nature:

Minor natural sources of free neutrons are produced by relatively rare accumulations of long-lived radioactive isotopes incorporated in a variety of minerals (e.g., Uraninite—UO₂; with U comprised of about 99.28% of ²³⁸U and 0.72% ²³⁵U and a trace of ²³⁴U) found in planetary crusts, asteroids, comets, and interstellar dust. In addition to such radioactive isotopes and various man-made sources of free neutrons noted earlier, natural sources of significant fluxes of free neutrons are found primarily in stellar environments. In fact, since the Big Bang, nearly all of the elements and isotopes found in the Universe besides hydrogen and helium have been created by a variety of cosmic nucleosynthetic processes associated with various stages of stellar evolution.

Stellar nucleosynthesis is a complex collection of various types of nuclear processes and associated nuclear reaction networks operating across an extremely broad range of astrophysical environments, stellar evolutionary phenomena, and time-spans. According to current thinking, these processes are composed of three broad classes of stellar nucleosynthetic reactions as follows:

1. Various nuclear reactions primarily involving fusion of nuclei and/or charged particles that start with hydrogen/helium as the initial stellar “feedstock” and subsequently create heavier isotopes up to ⁵⁶Fe (iron), at which the curve of nuclear binding energy peaks. At masses above ⁵⁶Fe, binding energies per nucleon progressively decrease; consequently, nucleosynthesis via fusion and charged particle reactions are no longer energetically favored. As a result, isotopes/elements heavier than ⁵⁶Fe must be created via neutron capture processes.

2. S-Process—short-hand for the Slow (neutron capture) Process; it is thought to occur in certain evolutionary stages of cool giant stars. In this process, “excess” neutrons (produced in certain nuclear reactions) are captured by various types of “seed” nuclei on a long time-scale compared to β-decays. Heavier nuclides are built-up via successive neutron captures that ascend the so-called beta-stability valley from ⁵⁶Fe (a common initial “seed” nucleus in stellar environments) all the way up to ²⁰⁹Bi (Bismuth). Masses above ²⁰⁹Bi require much higher neutron fluxes to create heavier elements such as Uranium (e.g. ²³⁸U).

3. R-Process—short-hand for the Rapid (neutron capture) Process; it is thought to occur in Type II supernovae and various high-energy events on and around neutron stars. In this process, intermediate products comprising very neutron-rich nuclei are built up by very large neutron fluxes produced under extreme conditions that are captured by various types of “seed” nuclei. These intermediate products then undergo a series of β-decays accompanied by fission of the heaviest nuclei. Ultimately, this process produces nuclei having even larger masses, i.e. above ²⁰⁹Bi, that are located on the neutron-rich side of the “valley of nuclear stability”.

As evident from the Table I discussed above, various types of neutron generators have been known for many years. However, the neutron generators of the prior art do not produce ultra low momentum neutrons. Two prior publications have mentioned or involve “ultracold” neutrons (which are created at significantly higher energies and much greater momenta than “ultra low momentum” neutrons), but these are easily distinguished from the present invention. Specifically, RU2160938 (entitled “Ultracold Neutron Generator,” by Vasil et al., dated Dec. 20, 2000) and RU2144709 (entitled “Ultracold Neutron Production Process,” by Jadernoj et al., dated Jan. 20, 2000) both utilize either large macroscopic nuclear fission reactors or accelerators as neutron sources to create thermal neutrons, which are then subsequently extracted and brought down to “ultracold” energies with certain neutron moderators that are cooled-down to liquid helium temperatures.

An object of the present invention is to provide method and apparatus for directly producing large fluxes of ultra low momentum neutrons (ULMNs) that possess much lower momentum and velocities than ultracold neutrons. Illustratively, such fluxes of ULMNs produced in the apparatus of the Invention may be as high as ˜10¹⁶ neutrons/sec/cm².

Another object of the present invention is to generate ULM neutrons at or above room temperature in very tiny, comparatively low cost apparatus/devices.

A further object of the present invention is to generate ULM neutrons without requiring any moderation; that is, without the necessity of deliberate “cooling” of its produced neutrons using any type of neutron moderator.

A further object of the present invention is to utilize controlled combinations of starting materials and successive rounds of ULM neutron absorption and beta decays to synthesize stable, heavier (higher-A) elements from lighter starting elements, creating transmutations and releasing additional energy in the process.

Yet another object of the present invention is to produce neutrons with extraordinarily high absorption cross-sections for a great variety of isotopes/elements. Because of that unique characteristic, the ULMN absorption process is extremely efficient, and neutrons will very rarely if ever be detected externally, even though large fluxes of ULMNs are being produced and consumed internally within the apparatus of the invention. One specific object of the present invention is to produce neutrons at intrinsically very low energies, hence the descriptive term “ultra low momentum” neutrons. ULM neutrons have special properties because, according to preferred aspects of the invention, they are formed collectively at extraordinarily low energies (which is equivalent to saying that at the instant they are created, ULMNs are moving at extraordinarily small velocities, v, approaching zero). Accordingly, they have extremely long quantum mechanical wavelengths that are on the order of one to ten microns (i.e., 10,000 to 100,000 Angstroms). By contrast, a “typical” neutron moving at thermal energies in condensed matter will have a quantum mechanical wavelength of only about 2 Angstroms. By comparison, the smallest viruses range in size from 50 to about 1,000 Angstroms; bacteria range in size from 2,000 to about 500,000 Angstroms. The great size of the domain of their wave function is the source of ULMNs' extraordinarily large absorption cross-sections; it enables them to be almost instantly absorbed by different local nuclei located anywhere within distances of up to 10,000 Angstroms from the location at which they are created.

### SUMMARY OF THE INVENTION

The present invention has numerous features providing methods and apparatus that utilize surface plasmon polariton electrons, hydrogen isotopes, surfaces of metallic substrates, collective many-body effects, and weak interactions in a controlled manner to generate ultra low momentum neutrons that can be used to trigger nuclear transmutation reactions and produce heat. One aspect of the present invention effectively provides a “transducer” mechanism that permits controllable two-way transfers of energy back-and-forth between chemical and nuclear realms in a small-scale, low-energy, scalable condensed matter system at comparatively modest temperatures and pressures.

One aspect of the invention provides a neutron production method in a condensed matter system at moderate temperatures and pressures comprising the steps of providing collectively oscillating protons, providing collectively oscillating heavy electrons, and providing a local electric field greater than approximately 10¹¹ volts/meter.

Another aspect of the invention provides a method of producing neutrons comprising the steps of: providing a hydride or deuteride on a metallic surface; developing a surface layer of protons or deuterons on said hydride or deuteride; developing patches of collectively oscillating protons or deuterons near or at said surface layer; and establishing surface plasmons on said metallic surface.

Another aspect of the invention provides a method of producing ultra low momentum neutrons (“ULMNs”) comprising: providing a plurality of protons or deuterons on a working surface of hydride/deuteride-forming materials; breaking down the Born-Oppenheimer approximation in patches on said working surface; producing heavy electrons in the immediate vicinity of coherently oscillating patches of protons and/or deuterons; and producing said ULMNs from said heavy electrons and said protons or deuterons.

According to another aspect of the invention, a nuclear process is provided using weak interactions comprising: forming ultra low momentum neutrons (ULMNs) from electrons and protons/deuterons using weak interactions; and locally absorbing said ULMNs to form isotopes which undergo beta-decay after said absorbing.

According to a further aspect of the invention, a method of generating energy is provided. At first sites, the method produces neutrons intrinsically having, upon their creation, ultra low momentum (ULMNs). A lithium target is disposed at a second site near said first sites in a position to intercept said ULMNs. The ULMNs react with the Lithium target to produce Li-7 and Li-8 isotopes. The lithium isotopes decay by emitting electrons and neutrinos to form Be-8; said Be-8 decaying to He-4. This reaction produces a net heat of reaction.

The foregoing method of producing energy may further comprise producing helium isotopes by reacting helium with ULMNs emitted from said first sites to form He-5 and He-6; the He-6 decaying to Li-6 by emitting an electron and neutrino; the helium-to-lithium reactions yielding a heat of reaction and forming a nuclear reaction cycle.

The present invention also provides a method of producing heavy electrons comprising: providing a metallic working surface capable of supporting surface plasmons and of forming a hydride or deuteride; fully loading the metallic surface with H or D thereby to provide a surface layer of protons or deuterons capable of forming coherently oscillating patches; and developing at least one patch of coherently or collectively oscillating protons or deuterons on the surface layer.

In addition, the present invention also provides apparatus for a nuclear reaction. Such apparatus comprises: a supporting material; a thermally conductive layer; an electrically conductive layer in contact with at least a portion of said thermally conductive layer; a cavity within said supporting material and thermally conductive layer; a source of hydrogen or deuterium associated with said cavity; first and second metallic hydride-forming layers within said cavity; an interface between a surface of said first hydride-forming layer, said interface being exposed to hydrogen or deuterium from said source; a first region of said cavity being located on one side of said interface and having a first pressure of said hydrogen or deuterium; a second region of said cavity being located on one side of said second hydride-forming layer and having a second pressure of said hydrogen or deuterium; said first pressure being greater than said second pressure; said apparatus forming a sea of surface plasmon polaritons and patches of collectively oscillating protons or deuterons, and ultra low momentum neutrons in a region both above and below said interface. Optionally, a laser may be positioned to irradiate said sea and said interface. An electrically conductive layer may form a portion of an inside wall of the cavity.

Another aspect of the present invention provides a neutron generator for producing ultra low momentum neutrons (“ULMNs”) comprising: a metallic substrate having a working surface capable of supporting surface plasmons and of forming a hydride or deuteride, located above the substrate. The metallic substrate is fully loaded with hydrogen or deuterium; a surface layer of protons or deuterons. At least one region of collectively oscillating protons or deuterons is on said surface layer, and surface plasmons are located above the surface layer and said region. A flux of protons or deuterons is incident on said surface plasmons, surface layer, and working surface. Optionally, a plurality of target nanoparticles can be positioned on the working surface.

Preferably, in the ULMN generator just mentioned, the Born-Oppenheimer approximation breaks down on the upper working surface. The invention may further comprise laser radiation incident on said working surface to stimulate and transfer energy into said surface plasmons.

### BRIEF DESCRIPTION OF THE DRAWINGS

In describing examples of preferred embodiment of the present invention, reference is made to accompanying figures in which:

FIG. 1 is a representative side view of a ULMN generator according to aspects of the present invention;

FIG. 2 is a representative top view of the ULMN generator of FIG. 1;

FIG. 3 is a representative side view of a ULMN generator according to aspects of the present invention, including optional nanoparticles;

FIG. 4 is a representative top view of the ULM generator of FIG. 3 with randomly positioned nanoparticles affixed to the working surface;

FIG. 5 is a representative schematic side sketch of one alternative preferred embodiment of a ULMN power generation system according to aspects of the present invention;

FIG. 6 is a representative schematic block diagram of another alternative preferred embodiment of a ULMN power generation system according to aspects of the present invention;

FIG. 7 is a representative schematic block diagram of another alternative preferred embodiment of a ULMN power generation system according to aspects of the present invention; and

FIG. 8 is a sketch useful in understanding some of the physics used in aspects of the present invention.

### DESCRIPTION OF PREFERRED EMBODIMENTS OF THE PRESENT INVENTION

One feature of the present invention provides a method for the creation of (preferably large fluxes of) ultra low momentum neutrons in condensed matter systems, preferably at very moderate temperatures and pressures in various preferred types of very compact, comparatively low cost apparatus. Absorption of ULMNs by nuclei within the invention's apparatus initiates the formation of complex, coupled networks of local, neutron-catalyzed nuclear reactions that are broadly referred to herein as Low Energy Nuclear Reactions or LENRs.

Commercially, fluxes of such ULMNs can be utilized to trigger ULMN-catalyzed LENRs in preferred target materials for the generation of excess heat and/or for inducing transmutation reactions that are used to create other desired isotopes of commercial value. Excess heat can be converted into other usable forms of energy using various preferred types of energy conversion technologies used in power generation.

Thus, an apparatus or method according to one aspect of the present invention forms neutrons from protons or deuterons and heavy electrons using the weak interaction. According to another aspect, it produces neutrons that intrinsically have very low momentum. According to yet another aspect, the heavy electrons that react with protons or deuterons to produce ULM neutrons and neutrinos serve a dual role by also effectively serving as a “gamma shield” against energetic gamma- and hard X-ray photons that may be produced as a result of ULM neutron absorption by nuclei and/or as a result of subsequent nuclear decay processes.

Preferably, in practicing the present invention, ULMNs are created solely through weak interactions between protons or deuterons and “heavy” electrons as defined in a paper by A. Widom and L. Larsen, the present inventors, entitled: “Ultra Low Momentum Neutron Catalyzed Nuclear Reactions on Metallic Hydride Surfaces,” available on the Cornell pre-print server as arXiv:cond-mat/0505026 v1 dated May 2, 2005, and further published in The European Physical Journal C—Particles and Fields (Digital Object Identifier 10.1140/epjc/s2006-02479-8). This contrasts sharply with the substantially “faster” (much higher momentum and kinetic energy) fission neutrons that are created via strong interactions involving high-A isotopes that are utilized in the existing nuclear power industry for generation of heat and transmutation of selected materials/isotopes.

According to another aspect of the invention, heavy electrons may serve as a built-in gamma shield, as defined in a paper by A. Widom and L. Larsen, the present inventors, entitled: “Absorption of Nuclear Gammna Radiation by Heavy Electrons on Metallic Hydride Surfaces,” also available on the Cornell pre-print server as arXiv:cond-mat/0509269 v1 dated Sep. 10, 2005. Heavy electrons formed in the preferred practice of the present invention have a unique property in that they have the ability to fully absorb a gamma ray photon coming from any direction and re-emit the absorbed energy in the form of an appropriately large number (based upon the conservation of energy) of lower-energy photons, mostly in the infrared, IR, with a small amount of radiation in the soft X-ray bands. In the range of heavy electron masses covered by the invention, gamma photons in the energy range of 0.5 MeV to ˜10.0 MeV are effectively “shielded” and converted into primarily infrared photons which are then in turn absorbed by nearby surrounding materials, thus producing heat. Since gamma photon energies from over 95% of all nuclear reactions fall within the natural active “shielding range” of the heavy electrons of the invention, very few energetic gammas will ever be detected outside the invention's apparatus. Consequently, from a biosafety perspective, the present invention requires little or no shielding against hard radiation produced by LENRs within the apparatus.

In comparison to thermal and fast neutrons (defined in Table I above), ULMNs have enormously larger absorption cross sections for virtually any given isotope of an element. Accordingly, according to another aspect of the present invention, ULMNs produced by the present invention are captured with extremely high efficiency in neighboring target materials in close proximity to their creation site, thus forming neutron-rich isotopes. Specifically, since large fluxes of ULM neutrons with very large absorption cross-sections are produced in the invention, multiple neutrons can be absorbed by a many nuclei before the next beta decay, thus creating extremely neutron-rich, unstable intermediate isotope products. With very few exceptions, such unstable, ultra neutron-rich isotopes decay extremely rapidly via chains of successive beta decays, forming stable higher-A isotopes as end-products. This novel feature of the invention results in there being little or no residual long-lived radioactivity after ULM neutron production shuts down. This attribute of the invention, in conjunction with extremely efficient absorption of ULMNs, production of large fluxes of ULMNs (as much as 10¹⁶ ULMNs/sec/cm²), and intrinsic suppression of hard radiation emission, will enable the development of a new type of much safer, lower-cost nuclear power generation technology that is based primarily on the weak interaction (neutron absorption and beta decays) rather than the strong interaction (fission, fusion).

It is well known that neutron-rich isotopes of many elements (excluding certain very high-A elements such as uranium, plutonium) are short-lived and decay mainly via weak interaction beta processes. Individual beta decays can be very energetic, and can have positive Q-values ranging up to ˜20 MeV. Q-values of many beta decays thus compare favorably to net Q-values that are achievable with D-D/D-T fusion reactions (total ˜25 MeV). Chains of energetic beta decays can therefore be utilized for generating power.

The present invention's novel approach to nuclear power generation is based primarily on utilization of the weak interaction. Preferably, chains of reactions characterized mainly by absorption of ULMNs and subsequent beta decays are employed (LENRs). In some cases, preferred ULMN-catalyzed chains of nuclear reactions may have biologically benign beta decays interspersed with occasional “gentle” fissions of isotopes of other elements and occasional alpha-particle decays. These may have Q-values ranging up to several MeV, in sharp contrast to the very energetic 200+ MeV Q-value of the fission of very high-A, ²³⁵U. It is important to note that significant fluxes of very high energy fission neutrons have never once been detected experimentally in LENR systems.

Importantly, since the invention utilizes primarily low energy, weak interaction nuclear processes, any production of large, biologically dangerous fluxes of hard radiation (very energetic X- and gamma rays), energetic neutrons, and long-lived highly radioactive isotopes can be avoided. Thus, the necessity for expensive shielding and containment of the invention's apparatus, and related waste disposal problems are obviated, in sharp contrast to existing nuclear fission and fusion technologies based on the strong interaction. Since no Coulomb barrier is involved in weak interactions and absorption of ULMNs, the invention's LENRs can take place under moderate physical conditions, unlike currently envisioned D-T (deuterium-tritium) fusion reactors.

Further scientific aspects of the present invention are set forth in the above-referenced paper by A. Widom and L. Larsen, the present inventors, entitled: “Ultra Low Momentum Neutron Catalyzed Nuclear Reactions on Metallic Hydride Surfaces.” The referenced Widom-Larsen paper is incorporated by reference, is intended to form part of this disclosure, and is attached hereto. The abstract of the referenced paper states: “Ultra low momentum neutron catalyzed nuclear reactions in metallic hydride system surfaces are discussed. Weak interaction catalysis initially occurs when neutrons (along with neutrinos) are produced from the protons which capture “heavy” electrons. Surface electron masses are shifted upwards by localized condensed matter electric fields. Condensed matter quantum electrodynamic processes may also shift the densities of final states allowing an appreciable production of ultra low momentum neutrons which are thereby efficiently absorbed by nearby nuclei. No Coulomb barriers exist for the weak interaction neutron production or other resulting catalytic processes.”

Similarly, further aspects of the present invention are set forth in the above-referenced paper by A. Widom and L. Larsen, the present inventors, entitled: “Absorption of Nuclear Gamma Radiation by Heavy Electrons on Metallic Hydride Surfaces,” available on the Cornell pre-print server as arXiv:cond-mat/0509269 v1 dated Sep. 10, 2005. The referenced Widom-Larsen paper is incorporated by reference, is intended to form part of this disclosure, and is also attached hereto. The abstract of the referenced paper states: “Low energy nuclear reactions in the neighborhood of metallic hydride surfaces may be induced by heavy surface electrons. The heavy electrons are absorbed by protons producing ultra low momentum neutrons and neutrinos. The required electron mass renormalization is provided by the interaction between surface electron plasma oscillations and surface proton oscillations. The resulting neutron catalyzed low energy nuclear reactions emit copious prompt gamma radiation. The heavy electrons which induce the initially produced neutrons also strongly absorb the prompt nuclear gamma radiation. Nuclear hard photon radiation away from metallic hydride surfaces is thereby strongly suppressed.”

While it is well known to use the strong interaction to achieve their primary utility as neutron generators, the present invention according to one of its aspects utilizes weak interactions between protons (p+) and “heavy” electrons (eₕ⁻) to produce a neutron (nᵤₗₘ) and a neutrino (νₑ)as follows:
eₕ⁻+p⁺→nᵤₗₘ+ ν̅ₑ

The first referenced paper by Widom and Larsen explains the physics of how, under the appropriate conditions, a proton is able to capture a “heavy” electron to create an ultra low momentum neutron (nᵤₗₘ) and a neutrino (photon). Similarly, they show how a deuteron (“D”) can capture one “heavy” electron to create two ultra low momentum neutrons and a neutrino as follows:
eₕ⁻+D⁺→2 nᵤₗₘ+ ν̅ₑ

Importantly, the Coulomb barrier is not a factor in either of these reactions. In fact, in this situation, unlike charges actually help these reactions to proceed.

The second referenced paper by Widom and Larsen explains the physics of how, under the appropriate conditions in certain condensed matter systems, a heavy, mass renormalized electron can fully absorb a high-energy gamma photon and re-radiate the absorbed energy as a much larger number of much lower-energy photons, mostly in the infrared along with a small amount of soft X-rays.

As noted earlier, quantum mechanical wave functions of ULMNs are very large, e.g., ˜10,000 to 100,000 Angstroms (1-10 microns); this is approximately the same size as coherent surface domain of oscillating protons or deuterons. According to Dr. S. K. Lamoreaux of Los Alamos National Laboratory, it would likely take roughly 1/10 to 2/10 of a millisecond for such a ULMN to interact with surrounding phonons in nearby materials and thermalize. As a newly created ULMN is “spooling-up” to much higher thermal energies, the spatial extent of its wave function (as well as implicitly, its capture cross section) will be contracting to dimensions (˜2 Angstroms) and a related cross section that are “normal” for neutrons at such energies. However, the ULMN absorption process is so rapid and efficient that thermal neutrons will rarely if ever be released and detected outside the apparatus of the invention.

“LENRs” represents a broad descriptive term encompassing a complex family of low energy nuclear reactions catalyzed by ULMNs. As explained in the referenced papers by Widom and Larsen, creation of ULMNs on surfaces requires a breakdown of the Born-Oppenheimer approximation, collectively oscillating “patches” of protons or deuterons, as well as excited surface plasmons and fully loaded metal hydrides. Creation of ULMNs and resulting LENRs (as ULMNs are absorbed by nearby atoms) occurs in and around small, solid-state nanodomains (dimensions on the order of tens of microns or less) located on or very near metallic surfaces or at interfaces between a metal and a dielectric such as a ceramic solid-state proton conductor. In these small scale, nuclear-active domains, production of high local fluxes of ULMNs enables LENRs to be triggered in nearby materials. In certain preferred embodiments, preferred local isotopic compositions can generate substantial amounts of excess heat that can then, for example, be transferred to another device and converted into electricity or rotational motion.

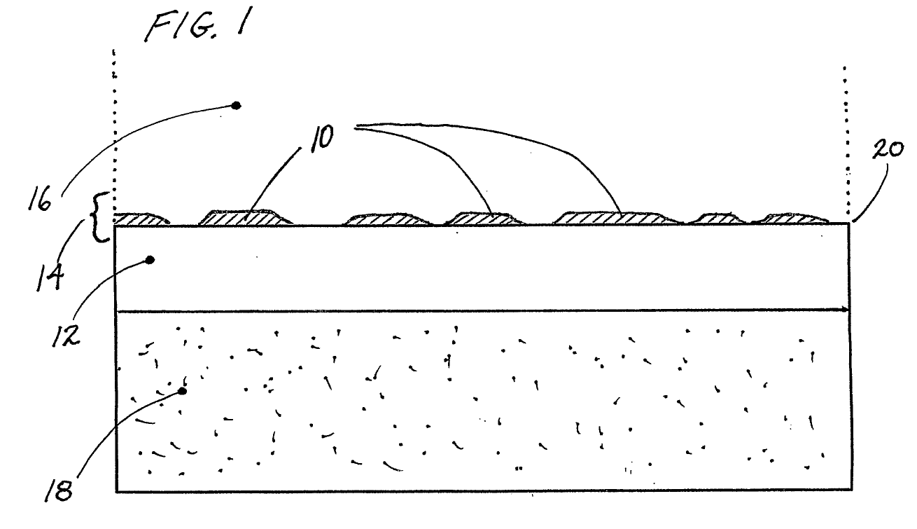

Turning now to the drawings, FIG. 1 is a representative side view of a ULMN generator according to aspects of the present invention. It consists of: randomly positioned surface “patches” from one to ten microns in diameter comprising a monolayer of collectively oscillating protons or deuterons 10; a metallic substrate 12 which may or may not form bulk hydrides; collectively oscillating surface plasmon polariton electrons 14 that are confined to metallic surface regions (at an interface with some sort of dielectric) within a characteristic skin depth averaging 200-300 Angstroms for typical metals such as copper and silver; an upper working region 16 which may be filled with a liquid, gas, solid-state proton conductor, or a mild vacuum; other substrate 18 which must be able to bond strongly with the metal substrate 12 and have good thermal conductivity but which may or may not be permeable to hydrogen or deuterium and/or form hydrides; and the working surface 20 of the metallic substrate 12 which may or may not have nanoparticles of differing compositions affixed to it. The upper working region 16 either contains a source of protons/deuterons or serves as a transport medium to convey ions, and/or electrons, and/or photons to the working surface 20 upon which the SPPs 14 are found.

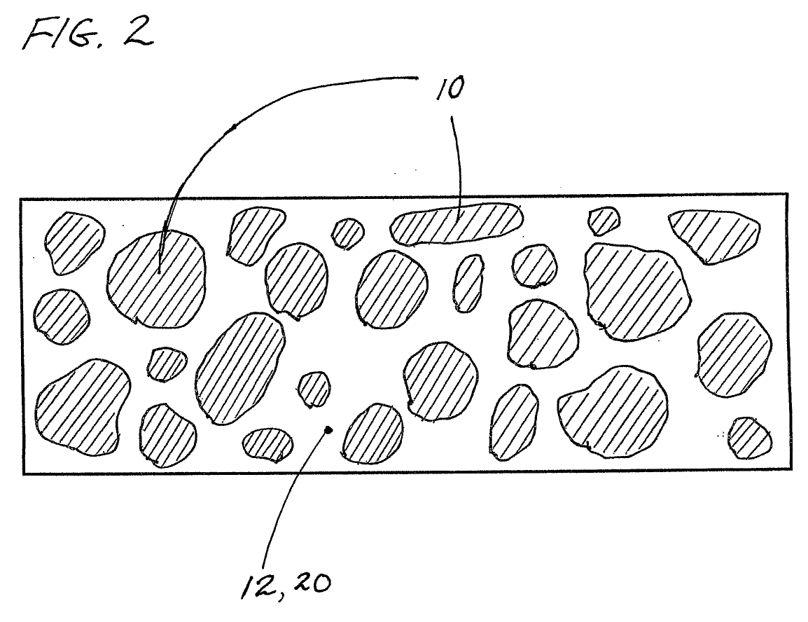

FIG. 2 is a representative top view of the apparatus of FIG. 1 according to aspects of the present invention. It shows randomly positioned “patches” of collectively oscillating protons or deuterons 10 located on top of the metallic substrate 12 and its working surface 20.

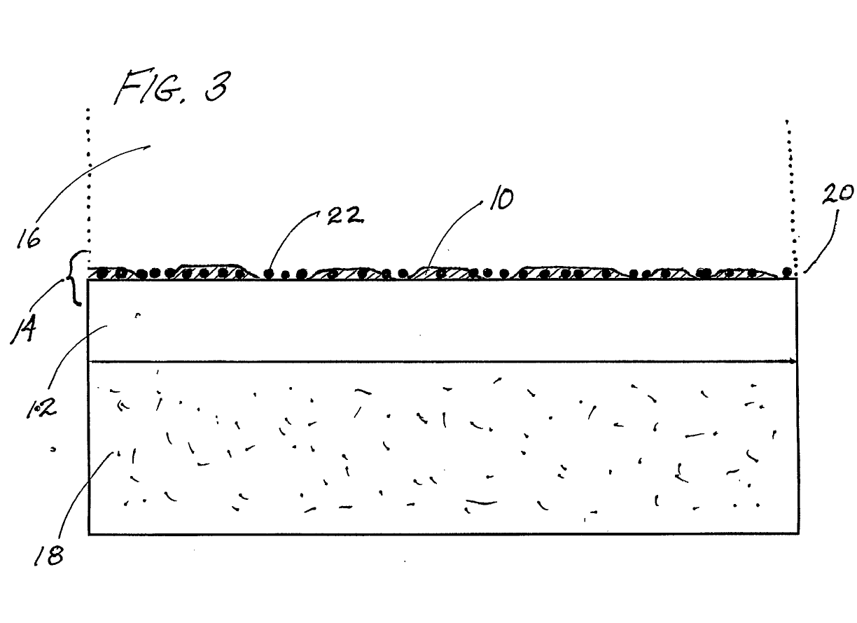

FIG. 3 is a representative side view of a ULMN generator according to aspects of the present invention. It shows the ULM generator of FIG. 1 with randomly positioned nanoparticles 22 affixed to the working surface 20. It is important that the maximum dimensions of the nanoparticles are less than the skin depth 14.

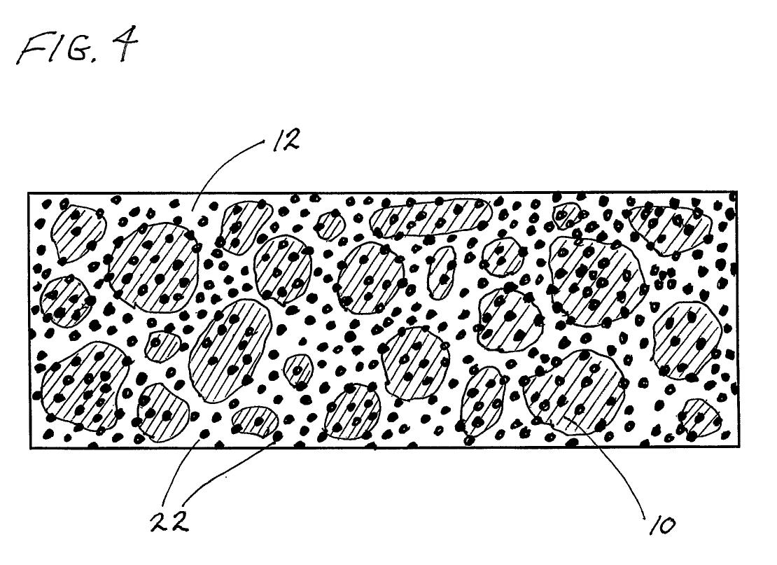

FIG. 4 is a representative top view of a ULMN generator according to aspects of the present invention. It shows the ULM generator of FIG. 3 with randomly positioned nanoparticles 22 affixed to the working surface 20.

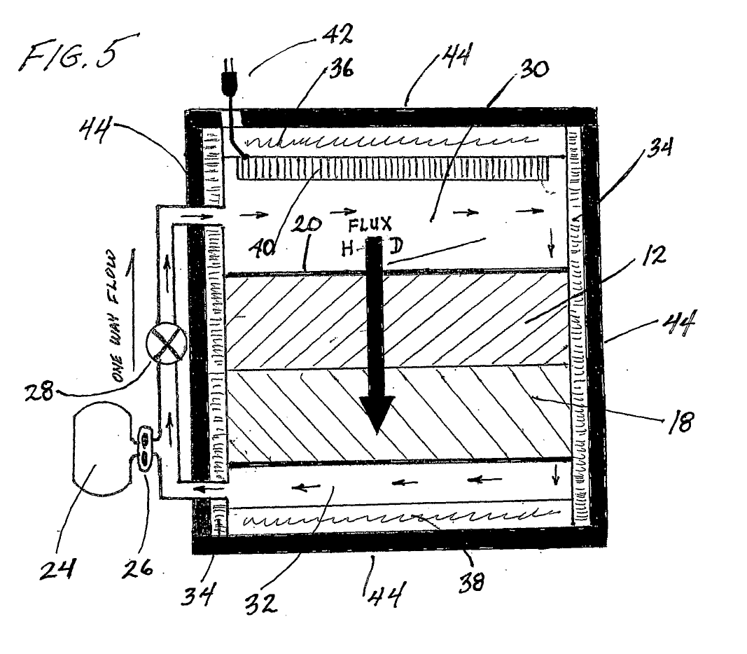

FIG. 5 is a representative schematic side view of one alternative preferred embodiment of a ULMN power generation system according to aspects of the present invention. It shows a pressurized reservoir of hydrogen or deuterium gas 24 connected via a valve 26 and related piping with an one-way check valve and inline pump 28 that injects gas under pressure (>1 atmosphere) into a sealed container with two open cavities 30, 32 separated and tightly sealed from each other by a one or two layer ULM neutron generator. The side walls 34 of the cavities 30, 32 are thermally conductive, relatively inert, and serve mainly to provide support for the ULM neutron generator. The top and bottom walls 36, 38 of the two cavities 30, 32 are preferably constructed of materials that are thermally conductive. Optionally, in other alternative embodiments in which a laser 40 and electrical connector 42 is not optionally installed on the top wall 36, then the top 36 and bottom 38 walls can be made electrically conductive and a desired electrical potential gradient can be imposed across the ULM generator. If an additional chemical potential in the ULM generator is desirable, the ULM generator can optionally be constructed with two layers 12, 18, both of which must be able to form bulk metallic hydrides, but their materials are selected to maximize the difference in their respective work functions at the interface between them. Each layer 12, 18 of the ULM generator must preferably be made thicker than the skin depth of surface plasmon polaritons, which is about 20-50 nanometers in typical metals. If a semiconductor laser 40 is optionally installed, it should be selected to have the highest possible efficiency and its emission wavelengths chosen to closely match the resonant absorption peaks of the SPPs found in the particular embodiment. The pressure gradient (from 1 up to 10 atmospheres) across the ULM generator insures that a sufficient flux of protons or deuterons is passing through the generator's working surface 20. Finally, the outermost walls of the container 44, completing enclosing the ULM generator unit (except for openings necessary for piping, sensors, and electrical connections), can be either solid-state thermoelectric/thermionic modules, or alternatively a material/subsystem that has an extremely high thermal conductivity such as copper, aluminum, Dylyn diamond coating, PocoFoam, or specially engineered heat pipes. In the case of the alternative embodiment having a ULM generator integrated with thermoelectric/thermionic devices, high quality DC power is generated directly from the ULM generator's excess heat; it serves as a fully integrated power generation system. In the other case where the container is surrounded by some type of thermal transfer components/materials/subsystems, the ULM generator functions as an LENR heat source that can be integrated as the “hot side” with a variety of different energy conversion technologies such as small steam engines (which can either run an electrical generator or rotate a driveshaft) and Stirling engines.

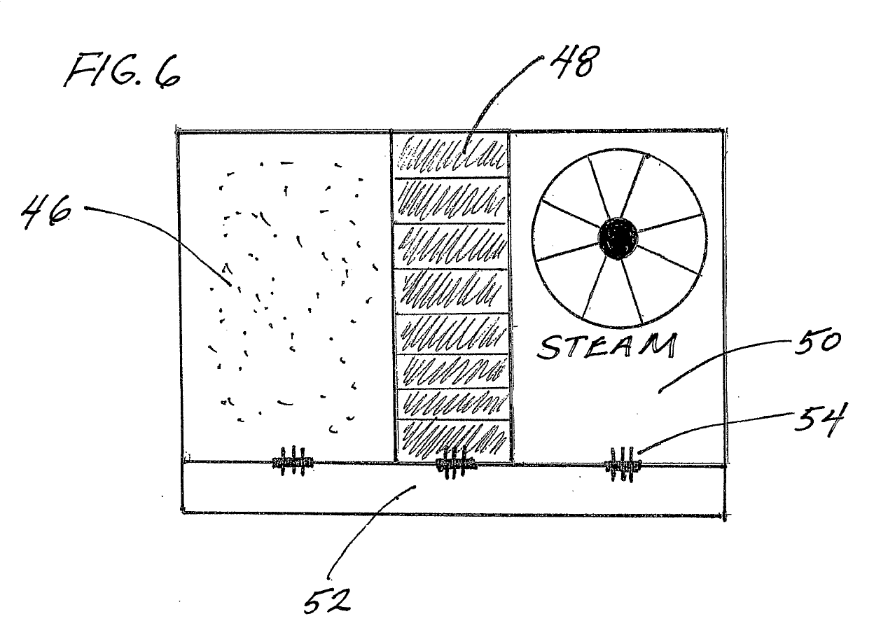

FIG. 6 is a representative schematic block diagram of another alternative preferred embodiment of a ULMN power generation system according to aspects of the present invention. It shows a subsystem 46 containing a ULM generator heat source (such as illustrated in FIG. 5) combined with a thermal transfer subsystem 48 that transfers heat to a steam engine 50 that converts heat into rotational motion that can either be used turn a driveshaft or an AC electrical generator. Overall operation of the ULM-based integrated power generation system is monitored and controlled by another subsystem 52 comprised of sensors, actuators, and microprocessors linked by communications pathways 54.

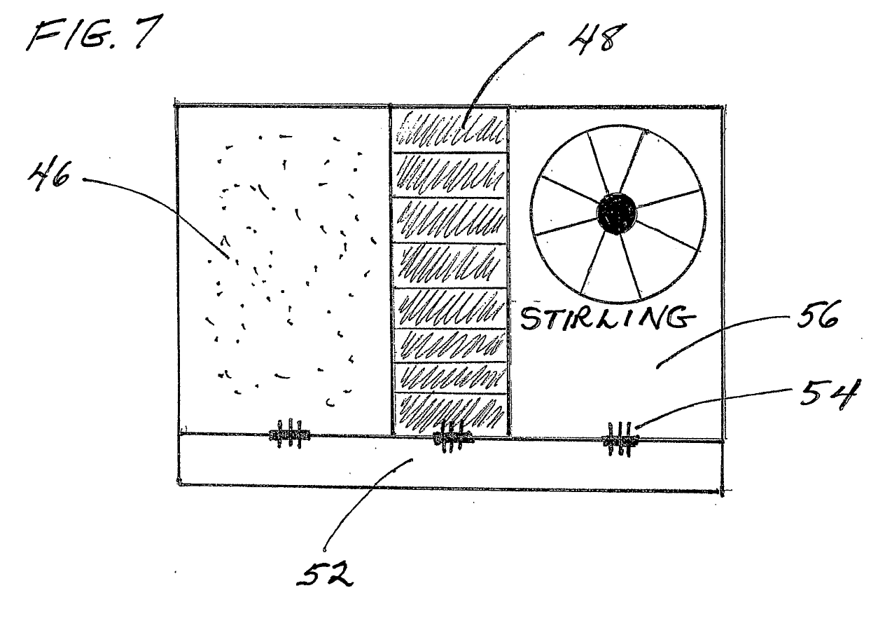

FIG. 7 is a representative schematic block diagram of another alternative preferred embodiment of a ULMN power generation system according to aspects of the present invention. It shows a subsystem 46 containing a ULM generator heat source combined with a thermal transfer subsystem 48 that transfers heat to a Stirling engine 56 that converts heat into rotational motion that can either be used turn a driveshaft or an AC electrical generator. Overall operation of the ULM-based integrated power generation system is monitored and controlled by another subsystem 52 comprised of sensors, actuators, and microprocessors linked by communications pathways 54.

Methods of Operation

In the case of a metallic substrate 12 that forms a bulk hydride, the first step in the operation of the Invention is to deliberately “load” 90-99% pure hydrogen or deuterium into a selected hydride-forming metallic substrate 12 such as palladium, nickel, or titanium. Examples of alternative preferred methods for such loading (some can be combined) include a: 1. Pressure gradient; 2. Enforced difference in chemical potential; and/or 3. Imposition of electrochemical potential across the working surface.

When a metallic hydride substrate 12 is “fully loaded” (that is, the ratio of H or D to metal lattice atoms in the metallic hydride substrate reaches a preferred value of 0.80 or larger), protons or deuterons begin to “leak out” and naturally form densely covered areas in the form of “patches” 10 or “puddles” positive charge on the working surface 20 of the metallic hydride substrate 12. The appearance of these surface patches of protons or deuterons can be seen clearly in thermal neutron scattering data. These surface patches 10 of protons or deuterons have dimensions that are preferably from one to ten microns in diameter and are scattered randomly across the working surface 20. Importantly, when these surface patches 10 form, the protons or deuterons that comprise them spontaneously begin to oscillate together, collectively, in unison.

The Born-Oppenheimer approximation will automatically break down in local regions of the working surface 20 that are in close proximity to surface patches 10 of collectively oscillating protons or deuterons. At this point, the collective motions of the electrons comprising the surface plasmon polaritons 14 become loosely coupled to the collective oscillations of local surface “patches” 10 of protons or deuterons. Energy can now be transferred back-and-forth between the surface patches 10 of protons or deuterons and the entire “sea” of SPPs covering the working surface 20.

Electromagnetic coupling between SPP electrons 14 and collectively oscillating patches of protons or deuterons dramatically increases strength of electric fields in the vicinity of the patches 10. As the local electric field strength of a patch increases, per the theory of Quantum Electrodynamics, the masses of local SPP electrons 14 exposed to the very high fields (preferably >10¹¹ Volts/meter) are renormalized upward (their real mass is increased). Such field strengths are essentially equivalent to those normally experienced by inner-shell electrons in typical atoms. Thus, in practicing the present invention, heavy electrons, e*− are created in the immediate vicinity of the patches 10 in and around the working surface 20. SPP electrons 14 in and around the patches can be heavy, those located away from the patches are not.

Beyond the initial loading phase to form a fully-loaded hydride substrate 12, electric fields in the vicinity of the H or D patches 10 must be further increased by injecting additional energy into the “sea” of surface plasmon polaritons 14. Ultimately, this has the effect of further increasing the rate of ultra low momentum neutron, ULMN production. This can be accomplished by using one or more the following preferred methods (some can be combined):

1. Creating a nonequilibrium flux of protons or deuterons as ions across the working surface interface 20 defined by the surface of the metallic hydride substrate (this is a rigid requirement in the case of a metallic substrate 12 that forms bulk hydrides); and/or,

2. Optionally, irradiating the metallic substrate's working surface 20 with laser 40 radiation of the appropriate wavelength that is matched to the photon absorption resonance peaks of the SPPs 14; this also has related surface roughness requirement to insure momentum coupling with the laser photons; and/or,

3. Optionally, irradiating the metallic substrate's 12 working surface 20 with an appropriately intense beam of either energetic electrons or other preferred types of energetic positive ions besides protons or deuterons.

When the renormalized masses of local SPP heavy electrons 14 reach critical threshold values, as described in the included Widom and Larsen papers referenced above, they will react spontaneously with collectively oscillating protons or deuterons in adjacent patches 10 in a weak interaction, thus producing ultra low momentum neutrons, ULMNs and neutrinos. As stated earlier, the two types of weak interaction nuclear reactions between protons or deuterons and heavy electrons that produce ULM neutrons and neutrinos are as follows:
p⁺+e*⁻=nᵤₗₘ+neutrino
d⁺+e*⁻=2nᵤₗₘ+neutrino

It must be emphasized that the strength of electric fields just above the patches is crucial to the production of ULM neutrons. If the local electric fields are not high enough (e.g., <<10¹¹ V/m) critical field strength thresholds will not be reached and the SPP electrons 14 will be short of the minimum mass necessary to react spontaneously with protons or deuterons to form ULM neutrons. It is well known in nanotechnology and the semiconductor industry that micron- and nano-scale surface features/topology and the size/geometry/placement of nanoparticles on surfaces can have dramatic effects on local E-M fields. The size regime for such effects starts at tens of microns and extends down to the nanoscale at roughly 5 nanometers. For example, it is known in nanotechnology that the relative size, composition, geometry, and relative placement (positioned to touch each other in a straight line versus a more close-packed arrangement) of nanoparticles on surfaces can cause the local electric fields to vary by 105. That factor is easily the difference between reaching the necessary thresholds to create ULM neutrons or not. The implication of these facts is that to successfully produce substantial percentages of good working ULMN neutron generator devices and operate them for significant periods of time, techniques must be used that are capable of nanoscale control of initial fabrication steps and materials/designs/methods must be selected that can maintain key surface properties during extended device operation. In that regard, ULM generators with an upper working region 16 that is filled with hydrogen or deuterium gas are more tractable from a surface stability standpoint, as compared to electrolytic ULM generators using an aqueous electrolyte in which the nanoscale surface features of the cathodes typically change dramatically over time.

FIGS. 3 and 4 illustrate a ULM generator in which nanoparticles 22 are fabricated and affixed to its working surface 20. FIG. 3 is a representative side view, not drawn to scale; FIG. 4 is a representative top view, also not drawn to scale. According to this particular embodiment, a ULM neutron generator would be constructed with a metallic substrate 12 that forms hydrides or deuterides, such as palladium, titanium, or nickel, or alloys thereof. Above that substrate is a working surface 20 capable of supporting surface plasmon polaritons 14 and the attachment of selected nanoparticles 22. The thickness of the substrate 12 and the diameter of the surface nanoparticles 22 should be fabricated so that they do not exceed the skin depth of the SPPs 14. The substrate 12 is fully loaded with H or D and the working surface 20 has an adequate coverage of patches 10 of protons or deuterons. In this embodiment the surface nanoparticles 22 serve as preferred target materials for ULM neutron absorption during operation of the generator. One example of a preferred nanoparticle target material for ULMN power generation applications are a variety of palladium-lithium alloys.

Palladium-lithium alloys represent an example of a preferable nanoparticle target material because: (a.) certain lithium isotopes have intrinsically high cross-sections for neutron absorption; (b.) nanoparticles composed of palladium-lithium alloys adhere well to palladium substrates; (c.) palladium-lithium alloys readily form hydrides, store large amounts of hydrogen or deuterium, and load easily; and finally (d.) there is a reasonably small, neutron-catalyzed LENR reaction network starting with Lithium-6 that produces substantial amounts of energy and forms a natural nuclear reaction cycle. Specifically, this works as follows (the graphic is excerpted from the referenced Widom-Larsen paper that published in The European Physical Journal C—Particles and Fields):

[image]

The net amount of energy (Q) released in the above LENR network compares favorably with that of strong interaction fusion reactions, yet it does not result in the production of energetic neutrons, hard radiation, or long-lived radioactive isotopes. Thus, substantial amounts of heat energy can be released safely by guiding the course of complex LENR nucleosynthetic and decay processes.

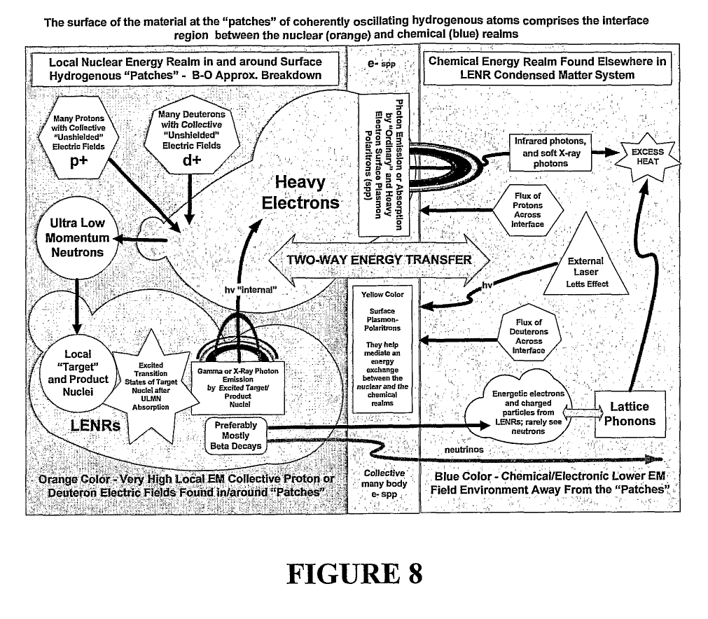

FIG. 8 is a representative sketch useful in understanding some of the scientific principles that are involved in various aspects of the present invention. As can be seen in FIG. 8, heavy electrons are produced in very high local collectively oscillating patches of protons or deuterons. These heavy electrons combine with the protons or deuterons to form the desired neutrons. These ULM neutrons, having extremely large cross sections of absorption, are quickly absorbed by the materials or targets in or upon the metallic substrate. As isotopes are produced, neutrinos and other reaction products are produced.

Commercial Utility of the Invention

There are important commercial uses for low cost, compact sources of high fluxes of ULMNs produced according to the present invention. ULMN production within such devices according to the teachings of the invention, in conjunction with methods for selection/fabrication of appropriate seed materials (nuclei/isotopes) and utilization of related LENR pathways, enables:

(a) High volume manufacturing of compact devices that can sustain in situ operation of ULMN-catalyzed networks of LENRs. Devices taught by the invention can be designed to exploit differences between the aggregate nuclear binding energies of preferred initial seed materials and the final products (isotopes) of the reaction networks to create an overall net release of energy, primarily in the form of excess heat. This heat would be generated primarily by preferred weak interactions such as beta decays. When integrated with a variety of preferred energy conversion technologies, LENR heat source devices enabled by the invention could prove to be valuable in a variety of commercial applications. The invention may have a substantial commercial advantage in comparison to competing nuclear power generation technologies (fission and fusion) that rely primarily on the strong interaction. In commercial power generation systems based on the Invention, disposal of hazardous waste products, radiation shielding, and related environmental and biosafety problems will not be significant concerns. The absence of any requirement for heavy shielding on the invention's LENR ULM neutron generator systems further enables the possibility of developing revolutionary low cost, very compact, long-lived, battery-like portable power sources; and

(b) Transmutation of various types of preferred seed materials/isotopes to produce significant recoverable quantities of specific, commercially useful isotopes.

Further modifications and changes will become apparent to persons skilled in the art after consideration of this description and drawings. The scope of the invention is preferred to be defined by the appended claims and equivalents thereof.

1. A neutron production method in a condensed matter system at moderate temperatures and pressures comprising:
providing collectively oscillating protons;
providing collectively oscillating heavy electrons; and
providing a local electric field greater than approximately 10¹¹ volts/meter.

2. The method of claim 1 wherein said providing collectively oscillating protons comprises providing a metallic substrate and fully loading at least the upper portion thereof with hydrogen or deuterium.

3. The method of claim 1 wherein the Born-Oppenheimer approximation breaks down on a working surface of a substrate.

4. A method of producing neutrons comprising the steps of:
providing a hydride or deuteride on a metallic surface;
developing a surface layer of protons or deuterons on said hydride or deuteride;
developing patches of collectively oscillating protons or deuterons near or at said surface layer; and
exciting surface plasmons on said metallic surface.

5. The method of claim 4 further comprising providing target materials on said metallic surface.

6. The method of claim 5 wherein the target materials are nanoparticles.

7. The method of claim 6 wherein the target materials are alloys.

8. The method of claim 7 wherein the target materials are Palladium-Lithium alloy.

9. The method of claim 4 and further comprising directing a flux of protons or deuterons toward said metallic surface.

10. The method of claim 4 and including loading hydrogen or deuterium via one or more of an enforced chemical potential difference, an electrical current, and a pressure gradient.

11. The method of claim 4 further comprising directing laser light toward said metallic surface.

12. The method of claim 4 wherein the neutrons are produced with intrinsically very low energies.

13. A method of producing ultra low momentum neutrons (“ULMNs”) comprising:
providing a plurality of protons or deuterons on a working surface of hydride/deuteride-forming materials;
breaking-down the Born-Oppenheimer approximation in patches on said working surface;
producing heavy electrons in the immediate vicinity of coherently oscillating patches of protons and/or deuterons; and
producing said ULMNs from said heavy electrons and said protons or deuterons.

14. The method of claim 13 including forming surface plasmon polaritons.

15. A nuclear process using weak interactions comprising:
forming ultra low momentum neutrons (ULMNs) from electrons and protons/deuterons using weak interactions; and
locally absorbing said ULMNs to form isotopes which undergo beta-decay after said absorbing.

16. A method of generating energy comprising the steps of:
at first sites, producing neutrons intrinsically having, upon their creation, ultra low momentum (ULMNs);
disposing a lithium target at a second site near said first sites in a position to intercept said ULMNs;
said ULMNs reacting with said Lithium target to produce Li-7 and Li-8 isotopes;
said lithium isotopes decaying by emitting electrons and neutrinos to form Be-8;
said Be-8 decaying to He-4;
said reaction producing a net heat of reaction.

17. The method of claim 16 further comprising:
producing helium isotopes by reacting helium with ULMNs emitted from said first sites to form He-5 and He-6;
said He-6 decaying to Li-6 by emitting an electron and neutrino;
said helium to lithium reactions yielding a heat of reaction and forming a nuclear reaction cycle.

18. A method of producing heavy electrons comprising:
providing a metallic working surface capable of supporting surface plasmons and of forming a hydride or deuteride;
fully loading said metallic surface with H or D thereby to provide a surface layer of protons or deuterons capable of forming coherently oscillating patches; and
developing at least one patch of coherently or collectively oscillating protons or deuterons on said surface layer.

19. The method of claim 18 including breaking down the Born-Oppenheimer approximation on said upper working surface.

20. The method of claim 18 wherein said metallic surface comprises a surface of palladium or a similar metal and/or alloy capable of forming a hydride or deuteride; and providing a plurality of target nanoparticles on said metallic working surface.

21. The method of claim 20 wherein said target nanoparticles comprise a palladium-lithium alloy.

22. The method of claim 18 further comprising directing laser radiation to said working surface to stimulate and transfer energy into said surface plasmons.

23. The method of claim 18 wherein said H or D surface layer is fully loaded by one or more of an enforced chemical potential difference, an electrical current, or a pressure gradient.

24. Apparatus for a nuclear reaction comprising:
a supporting material;
a thermally conductive layer;
an electrically conductive layer in contact with at least a portion of said thermally conductive layer;
a cavity within said supporting material and thermally conductive layer;
a source of hydrogen or deuterium associated with said cavity;
first and second metallic hydride-forming layers within said cavity;
an interface between a surface of said first hydride-forming layer, said interface being exposed to hydrogen or deuterium from said source;
a first region of said cavity being located on one side of said interface and having a first pressure of said hydrogen or deuterium;
a second region of said cavity being located on one side of said second hydride-forming layer and having a second pressure of said hydrogen or deuterium;
said first pressure being greater than said second pressure;
said apparatus forming a sea of surface plasmon polaritons and patches of collectively oscillating protons or deuterons, and ultra low momentum neutrons in a region both above and below said interface.

25. The apparatus of claim 24 wherein a Fermi-level difference between said first and second layers is greater than or equal to about 0.5 eV.

26. The apparatus of claim 24 further comprising a laser positioned to irradiate said sea and said interface.

27. The apparatus of claim 24 further comprising an electrically conductive layer forming a portion of an inside wall of said cavity.

28. A neutron generator for producing ultra low momentum neutrons (“ULMNs”) comprising:
a metallic substrate having a working surface capable of supporting surface plasmons and of forming a hydride or deuteride, located above said substrate;
said metallic substrate being fully loaded with hydrogen or deuterium;
a surface layer of protons or deuterons;
at least one region of collectively oscillating protons or deuterons on said surface layer;
surface plasmons located above the surface layer and said region; and
a flux of protons or deuterons incident on said surface plasmons, surface layer, and working surface.

29. The ULMN generator of claim 28 further comprising a plurality of target nanoparticles on said working surface.

30. The ULMN generator of claim 28 wherein the Born-Oppenheimer approximation breaks down on said upper working surface.

31. The ULMN generator of claim 28 wherein said substrate comprises palladium or a similar metal and/or alloy capable of forming a hydride or deuteride.

32. The ULMN generator of claim 28 further comprising laser radiation incident on said working surface to stimulate and transfer energy into said surface plasmons.

33. The ULMN generator of claim 29 wherein said target nanoparticles comprise a palladium-lithium alloy.

34. The ULMN generator of claim 28 wherein said H or D surface layer is fully loaded by one or more of an enforced chemical potential difference, an electrical current, or a pressure gradient.
